(19) United States
(12) Patent Application Publication
(10) Pub. No.: US 2013/0170559 A1
(43) Pub. Date: Jul. 4, 2013

(54) SYSTEMS AND METHODS FOR REGION OF INTEREST VIDEO PROCESSING

(71) Applicants: Martin Schink, Aachen (DE); Markus Kramer, Aachen (DE); Thorsten Schumann, Vaals (NL)

(72) Inventors: Martin Schink, Aachen (DE); Markus Kramer, Aachen (DE); Thorsten Schumann, Vaals (NL)

(73) Assignee: Rovi Technologies Corporation, Santa Clara, CA (US)

(21) Appl. No.: 13/338,571

(22) Filed: Dec. 28, 2011

(51) Int. Cl. H04N 7/26

(52) U.S. Cl. 375/240.25; 375/240.27; 375/E07.027; 375/E07.055

(57) ABSTRACT

Systems and methods for encoding regions of interest within video frames to reduce errors within the regions of interest in accordance with embodiments of the invention are described. One embodiment includes a processor configured by an encoder application, where the encoder application configures the processor to: identify at least one region of interest within a frame of video; assign at least one importance value to a plurality of regions within the frame, where a higher importance value is assigned to identified regions of interest; and apply a first error propagation reduction process to at least one region assigned a first importance value and a second error propagation reduction process to at least one region assigned a second importance value.

### FIELD OF THE INVENTION

The present invention generally relates to video processing and more specifically to systems and methods for classifying, encoding, decoding and transmitting video content based upon regions of interest.

### BACKGROUND OF THE INVENTION

The amount of data required to store video can be reduced using video encoding. A number of standards have been developed to facilitate the encoding and sharing of video. H.264 is a block-oriented motion-compensation based codec standard developed by the Telecommunication Standardization Sector's Video Coding Experts Group together with the International Organization for Standardization (ISO), International Electro technical Commission (IEC) and Moving Picture Experts Group (MPEG). H.264 includes a number of features that generally allow it to encode video effectively and provide more flexibility for applications in a wide variety of network environments.

Among the many features of H.264 is the ability to divide up an image into slice groups that define regions of an image. Each slice group can also be divided into several slices that are each a sequence of macroblocks. A macroblock is an image compression component that defines a still image or video frame as two or more blocks of pixels. These macroblocks can be processed in a scan order, such as left to right and top to bottom. Also, each slice can be decoded independently.

### SUMMARY OF THE INVENTION

Systems and methods in accordance with embodiments of the invention encode regions of interest within video frames to reduce errors within the regions of interest. One embodiment includes a processor configured by an encoder application, where the encoder application configures the processor to: identify at least one region of interest within a frame of video; assign at least one importance value to a plurality of regions within the frame, where a higher importance value is assigned to identified regions of interest; and apply a first error propagation reduction process to at least one region assigned a first importance value and a second error propagation reduction process to at least one region assigned a second importance value.

In a further embodiment in the first importance value is higher than the second importance value.

In another embodiment, the first error propagation reduction is more computationally intensive than the second error propagation reduction process.

In a still further embodiment, the first error propagation reduction process is an adaptive intra refresh encoding process.

In still another embodiment, the second error propagation reduction process involves performing no additional error propagation reduction processing.

In a yet further embodiment, the encoder application configures the processor to encode each video frame as a set of slice groups and to assign at least one importance value to each slice group.

In yet another embodiment, the encoder application configures the processor to group the slice groups in each frame based upon the importance values assigned to the slice groups.

In a further embodiment again, the encoder application configures the processor to assign importance values based upon user input.

In another embodiment again, the encoder application configures the processor to automatically assign importance values using an automated region of interest detection process.

A further additional embodiment includes identifying at least one region of interest within a frame of video using a source encoder, assigning at least one importance value to a plurality of regions within the frame using a source encoder, where a higher importance value is assigned to identified regions of interest, and applying a first error propagation reduction process to at least one region assigned a first importance value and a second error propagation reduction process to at least one region assigned a second importance value using the source encoder

In another additional embodiment, the first importance value is higher than the second importance value.

In a still yet further embodiment, the first error propagation reduction is more computationally intensive than the second error propagation reduction process.

In still yet another embodiment, the first error propagation reduction process comprises an adaptive intra refresh encoding process.

In a still further embodiment again, the second error propagation reduction process comprises performing no additional error propagation reduction processing.

Still another embodiment again includes a processor configured by a decoder application, where the decoder application configures the processor to: receive data including a sequence of encoded video frames; decode the sequence of encoded video frames; apply a first error concealment process when a region of a frame of video has a first importance value; and apply a second error concealment process when a region of a frame of video has a second importance value.

In a still further additional embodiment, the first importance value is higher than the second importance value.

In still another additional embodiment, the first error concealment process is more computationally intensive than the second error concealment process.

In a yet further embodiment again, each video frame is encoded as a set of slice groups and each slice group is assigned at least one importance value.

In yet another embodiment again, each video frame is encoded so that the slice groups are grouped based upon importance value.

In a yet further additional embodiment, the decoder application configures the processor to decode slice groups having higher importance values before slice groups having lower importance values.

In yet another additional embodiment, the first error concealment process includes at least one process selected from the group consisting of an interlayer error concealment process, a temporal error concealment process and a spatial error concealment process.

In a further additional embodiment again, the importance values are included in the encoded video.

In another additional embodiment again, the decoder application configures the processor to assign at least one importance value to regions of the sequence of encoded frames of video.

Another further embodiment includes receiving data including a sequence of encoded video frames using a playback device, decoding the sequence of encoded video frames using the playback device, applying a first error concealment process when a region of a frame of video has a first importance value using the playback device, and applying a second error concealment process when a region of a frame of video has a second importance value using the playback device.

In still another further embodiment, the first importance value is higher than the second importance value.

In yet another further embodiment, the first error concealment process is more computationally intensive than the second error concealment process.

In another further embodiment again, the first error concealment process includes at least one process selected from the group consisting of an interlayer error concealment process, a temporal error concealment process and a spatial error concealment process.

Another further additional embodiment includes a machine readable medium containing processor instructions, where execution of the instructions by a processor causes the processor to perform a process including: identifying at least one region of interest within a frame of video using a source encoder; assigning at least one importance value to a plurality of regions within the frame using a source encoder, where a higher importance value is assigned to identified regions of interest; and applying a first error propagation reduction process to at least one region assigned a first importance value and a second error propagation reduction process to at least one region assigned a second importance value using the source encoder.

In still yet another further embodiment, the machine readable medium is non-volatile memory.

Still another further embodiment again includes a machine readable medium containing processor instructions, where execution of the instructions by a processor causes the processor to perform a process including: receiving data including a sequence of encoded video frames using a playback device; decoding the sequence of encoded video frames using the playback device; applying a first error concealment process when a region of a frame of video has a first importance value using the playback device; and applying a second error concealment process when a region of a frame of video has a second importance value using the playback device.

In still another further additional embodiment, the machine readable medium is non-volatile memory.

### BRIEF DESCRIPTION OF THE DRAWINGS

FIG. 1 is a system diagram of a video distribution system in accordance with an embodiment of the invention.

FIG. 2A illustrates a source encoder in accordance with an embodiment of the invention.

FIG. 2B illustrates a playback device in accordance with an embodiment of the invention.

FIG. 2C illustrates a content distribution server in accordance with an embodiment of the invention.

FIG. 3 conceptually illustrates a process for identifying regions of interest within a frame of video and assigning relative importance to the macroblocks within the encoded frame of video based upon the region of interest in accordance with an embodiment of the invention.

FIG. 4 illustrates a process for encoding video to reduce error propagation in regions of interest in accordance with an embodiment of the invention.

FIG. 5 illustrates a process for performing error concealment according to slice group importance in accordance with an embodiment of the invention.

FIG. 6 is a diagram illustrating decoding slice groups within a frame of video based upon the importance of the slice group in accordance with an embodiment of the invention.

FIG. 7 illustrates a method of transmitting slice groups for decoding in order of importance in accordance with an embodiment of the invention.

### DETAILED DESCRIPTION OF THE DRAWINGS

Turning now to the drawings, systems and methods for encoding regions of interest within video frames to reduce errors within the regions of interest in accordance with embodiments of the invention are illustrated. The differences between the decoded frame and the encoded frame are typically referred to as errors. These errors can be caused by loss of information during the encoding process and/or loss of information during the transmission of data. In a number of embodiments, different regions within a frame of video are assigned different levels of importance or importance values. Based upon the importance value assigned to each region, a video encoder can assign additional resources to the encoding of the more important regions to reduce the number of errors in that region when the video frame is decoded. Likewise, a decoder can also assign additional resources to the decoding of the more important regions to conceal any errors that may have been introduced during the transmission process. In many embodiments, the importance values assigned to regions within frames of video determine the treatment of the region throughout the encoding, transmission and decoding of the video frame.

Regions of interest are generally regions within a video frame containing visual information that is important to a viewer. Regions of interest within a frame of video and/or video sequence can be determined manually by a user or automatically by an automated region of interest detection process. In several embodiments, automated detection of regions of interest is performed by identifying moving foreground objects as regions of interest within a sequence of video frames. In many embodiments, higher importance values are assigned to regions of interest relative to background information and/or other portions of the video that are determined to have lower importance to the viewer.

Once importance values are assigned to different regions of interest within a video frame and/or sequence of video frames, encoders in accordance with embodiments of the invention can perform varying levels of error propagation reduction or error resilient encoding to each portion of a video frame based upon the assigned importance values. Error propagation reduction reduces the likelihood that a specific portion of an encoded frame of video will include errors or differences with respect to the original frame of video when decoded. Error propagation reduction can be achieved using various techniques, which are discussed below. In a number of embodiments, adaptive intra refresh is utilized to encode regions having higher importance values. In other embodiments, any of a variety of error propagation reduction processes can be utilized in the encoding of different regions of a frame having different importance values.

Importance values can also be utilized during the decoding of video to perform error concealment. Error concealment is a process that involves reducing the errors in decoded video that result from data loss. Error concealment can be performed in many ways such as (but not limited to) a computationally cheap replacement from a previous frame or using more computationally expensive interlayer, temporal or spatial concealment. In a number of embodiments of the invention, a decoder applies more computationally expensive error concealment processes to regions of a video frame having a high importance value and less computationally expensive error concealment processes to regions having lower importance values.

In many embodiments, portions of a frame of video are transmitted from an encoder to a decoder in an order that prioritizes the regions of video based upon assigned importance value. In principle, the order of importance can be chosen freely and be transmitted with each video frame, which creates additional overhead. However, in many embodiments of the invention, this order would no longer need to be transmitted as it is understood that the more important regions of interest are transmitted earlier. In this way, communication overhead can be reduced as the transmission and decoding order is fixed to send more important macroblocks first, eliminating the need to transmit additional information relating to transmission and decoding order.

Although certain embodiments are discussed above, there are many additional ways to implement preferential treatment of regions of importance in video processing in accordance with many embodiments of the invention. System architectures that implement preferential treatment of regions of importance in video processing are discussed in greater detail below.

### System Architecture

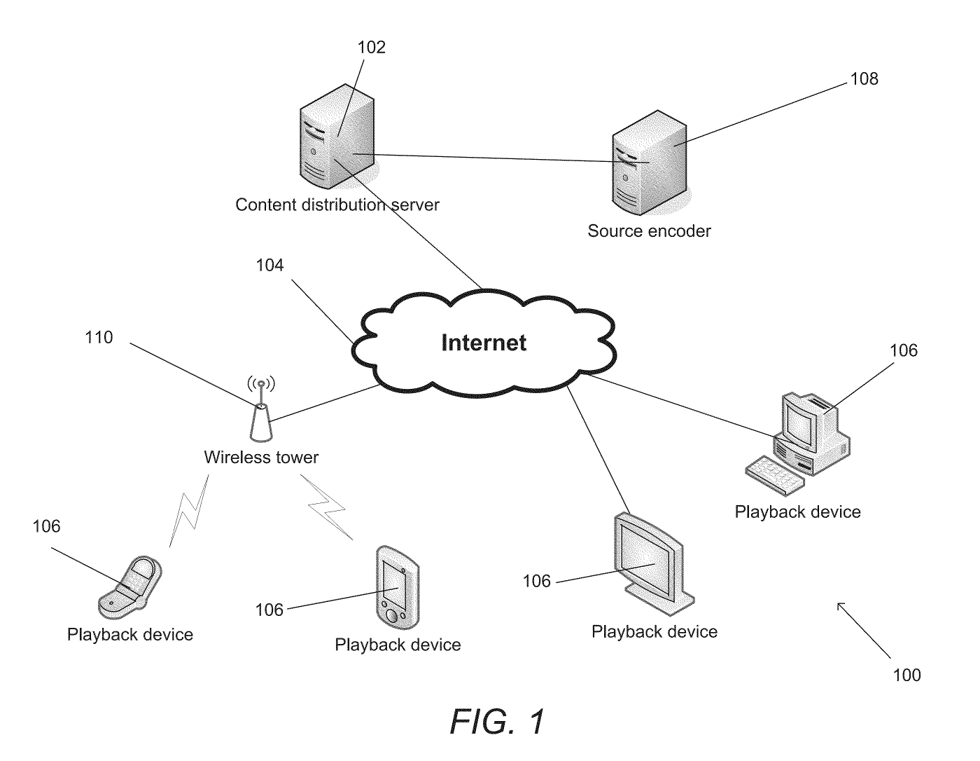

Video encoded in accordance with many embodiments of the invention can be transmitted to playback devices via the Internet. In many instances, data is lost during transmission and performing encoding and decoding based upon importance values assigned to regions of interest can reduce the perceptible impact of data loss during playback of the video on a playback device. A video distribution system in accordance with an embodiment of the invention is illustrated in FIG. 1. The system 100 includes a number of different playback devices 106 connected with a content distribution server 102 over the Internet 104. A number of playback devices 106 communicate wirelessly with a cellular data network 110 to connect to the Internet 104. Wireless connections are typically more lossy than direct wired connections and present a challenge for video reconstruction, requiring more error propagation reduction or error concealment to achieve the same video quality of a wired connection. A source encoder 108, configured to encode video distributed from the content distribution server 102, is connected with the content distribution server 102. The source encoder 108 can be configured to encode video with at least one region of interest rated with a degree of importance. The playback devices 106 can include playback processes configured to decode encoded video from the source encoder 108. Thereby, encoding, decoding and transfer of a video stream from the source encoder 102 to a playback device 106 can occur that prioritizes important regions of interest in a video. Although video transmitted to playback devices via the internet is mentioned above, video can be transmitted to playback devices in any manner as appropriate to specific applications in accordance with many embodiments of the invention, including over a local access network or by removable memory, such as a CD-ROM.

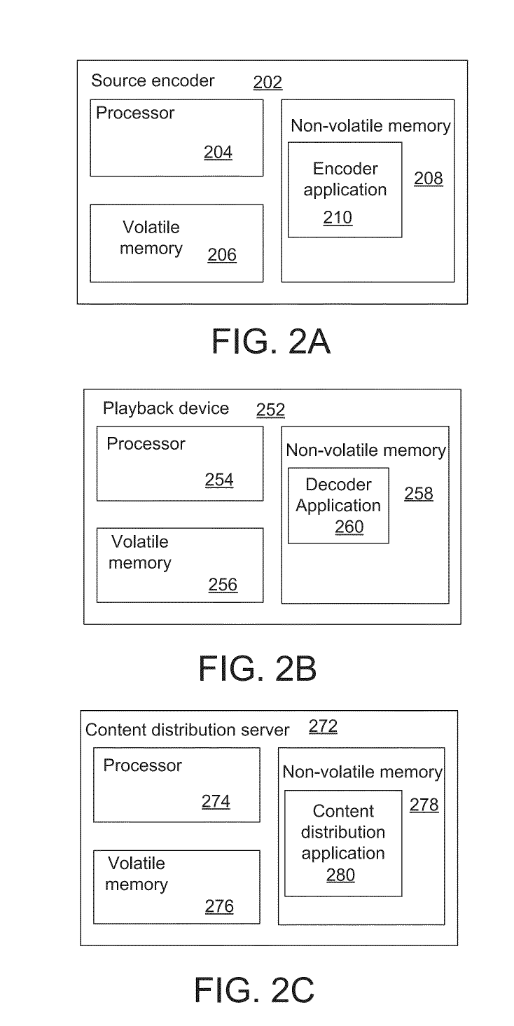

Source encoders in accordance with many embodiments of the invention can load an encoder application as machine readable instructions from memory or other storage. A source encoder in accordance with an embodiment of the invention is illustrated in FIG. 2A. The source encoder 202 includes a processor 204, volatile memory 206 and non-volatile memory 208 that includes an encoder 210. In the illustrated embodiment, the non-volatile memory 208 is a machine readable media that is utilized to store the machine readable instructions that configure the processor 204. The non-volatile memory 208 contains an encoder application 210, which is utilized to configure the processor 204 to encode video.

Similarly, playback devices in accordance with many embodiments of the invention can load a decoder application as machine readable instructions from memory. A playback device in accordance with an embodiment of the invention is illustrated in FIG. 2B. The playback device 252 includes a processor 254, volatile memory 256 and non-volatile memory 258 that includes a decoder application 260. In the illustrated embodiment, the non-volatile memory 258 is a machine readable media that is utilized to store the machine readable instructions that configure the processor 254. Here, the non-volatile memory 258 contains the instructions of a decoder application 260, which can be utilized to configure the processor 254 to decode video. In many embodiments, a decoder application can be loaded from any kind of memory or storage device including volatile memory in accordance with many embodiments of the invention.

Likewise, content distribution servers in accordance with many embodiments of the invention can load a content distribution application as machine readable instructions from memory. A content distribution server in accordance with an embodiment of the invention is illustrated in FIG. 2C. The content distribution server 272 includes a processor 274, volatile memory 276 and non-volatile memory 278 that includes a content distribution application 280. In the illustrated embodiment, the non-volatile memory 278 is a machine readable media that is utilized to store the machine readable instructions that configure the processor 274. Here, the non-volatile memory 278 contains the instructions of a content distribution application 280, which can be utilized to configure the processor 274 to distribute video. In many embodiments, a content distribution application can be loaded from any kind of memory or storage device including volatile memory in accordance with many embodiments of the invention.

Although a video distribution system is described above with respect to a specific source encoder, content distribution server and playback devices, any of a variety of encoding, transmitting or decoding systems can be utilized in the encoding, decoding and transmission of video as appropriate to specific applications in accordance with many embodiments of the invention. Assignment of importance values in accordance with embodiments of the invention are discussed below.

### Assigning Importance Values

Source encoders in accordance with many embodiments of the invention utilize information concerning the relative importance of different regions of video frames to prioritize the application of error propagation reduction encoding processes to different regions of a video frame during encoding. Important regions can be identified using region of interest detection processes. Each region of interest can be assigned an importance value. In block based encoding, importance values can be assigned to different slice groups corresponding to the regions of interest. Different error propagation reduction processes can then be applied to each slice group based upon the importance value assigned to the slice group.

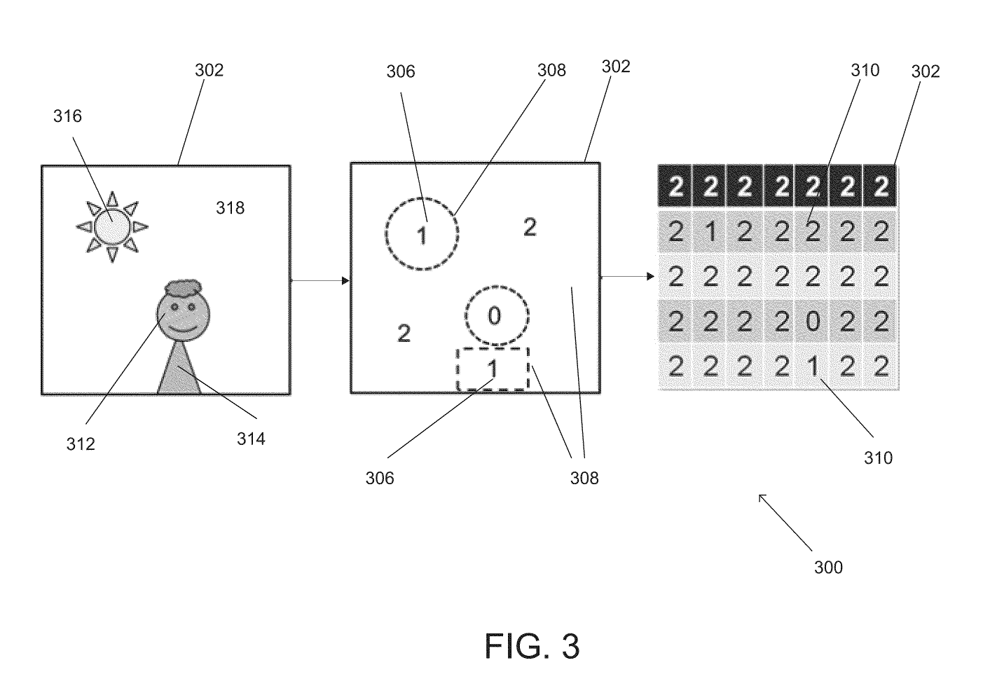

A diagram conceptually illustrating a process of determining regions of interest within a video frame and assigning importance values to slice groups within the frame for use during the encoding and decoding of the frame in accordance with an embodiment of the invention is shown in FIG. 3. The diagram 300 includes a video frame 302 including regions of interest 308 are identified and assigned importance values 306, where 0 labels the most important region and 2 labels the least important region. Each region of interest 308 corresponds to one or more slice groups 310 in the encoded frame of video. The importance values assigned to each region in the video frame can be transferred to corresponding slice groups in the video frame. In the illustrated embodiment, the video frame 302 can be divided into three different regions of interest where the individual's head 312 is the most important region, the individual's body 314 and the sun 316 are assigned a lower importance value and the background 318 of the image is assigned the lowest importance value. The video frame 302 can then be represented by slice groups 310 with associated importance values 306.

There are many processes that can be utilized to identify regions of interest in video. Manual processes can be utilized, such as where a user manually tags a region of interest or utilizes a user eye tracking device. Automated processes such as content recognition systems can also be used, such as by defining a region of interest to be an area of greater contextual complexity or movement in a video. Still other automated region of interest processes may define a region of interest through detection of object boundaries or contours that fall under certain criteria such as size, shape or amount of movement. Although certain region of interest detection processes are discussed above, any kind of detection of a region of interest to a user in accordance with embodiments of the invention may be made. Error propagation reduction for video in accordance with embodiments of the invention are discussed below.

### Error Propagation Reduction

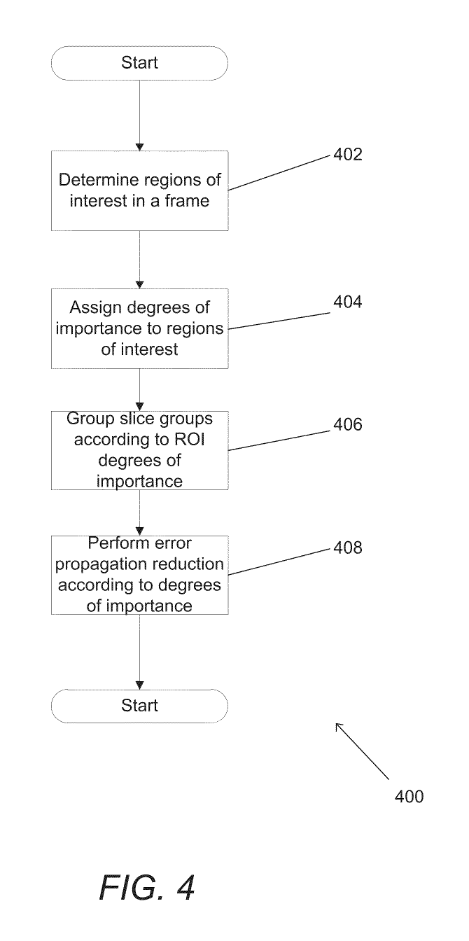

Error propagation reduction can be performed on different regions of a video frame based upon the importance values assigned to the regions in accordance with many embodiments of the invention. A process for encoding video by assigning importance values to different regions of video frames and performing error propagation reduction based upon the assigned importance values in accordance with an embodiment of the invention is illustrated in FIG. 4. The process 400 includes determining (402) regions of interest in a video frame using any of a variety of processes including those outlined above. The process 400 also includes assigning (404) importance values to the regions in the video frame, grouping (406) slice groups according to the assigned importance value of each associated region and performing (408) error propagation reduction according to the degrees of importance of each slice group.

In many embodiments, resource intensive error propagation reduction is performed upon slice groups with greater degrees of importance. Typically, the ability to perform more computationally intensive processes results in improved error propagation reduction. Error propagation reduction can be performed in many ways in various embodiments, such as increasing the amount of data sent in a slice group so that data loss will be inconsequential to the overall slice group video quality. In many embodiments where block based encoding is used, error propagation reduction can be performed using an adaptive intra refresh encoding process. Adaptive intra refresh is a technique of error propagation reduction that adapts the intra-refresh rate of macroblocks according to factors including video transmission conditions and video content. Intra refreshing allows for a column of intra blocks to move across a video from one side to the other, “refreshing” the frame. Regions of interest can be prioritized using adaptive intra refresh by increasing the intra-refresh rate for regions of interest.

In a number of embodiments, intra refresh is utilized to perform error propagation reduction process with respect to regions of the video frame assigned a high importance value. In several embodiments, an error propagation reduction process applied to regions of the video frame assigned a lower importance value can be any process including (but not limited to) a processes selected from the group consisting of reference picture identification, gradual decoding refresh, redundant slices, reference picture marking repetition, spare picture signaling, scene informant signaling and constrained intra prediction. In many embodiments, no error propagation reduction process is applied to regions of the video frame assigned a low importance value. In certain embodiments, any of a variety of error propagation reduction processes can be applied to regions of the video frame assigned a high importance value and/or a lower importance value as appropriate to the requirements of a specific application.

Although certain error propagation reduction processes are discussed above, many error propagation process can be utilized in accordance with various embodiments of the invention including (but not limited to) reference picture identification, gradual decoding refresh, redundant slices, reference picture marking repetition, spare picture signaling, scene informant signaling and constrained intra prediction. Error concealment for video decoding in accordance with embodiments of the invention is discussed below.

### Error Concealment

Decoders in accordance with many embodiments of the invention can apply different levels of error concealment based upon the importance value assigned to specific regions of a frame of video. When video data is lost or corrupted during transmission, any frame that is encoded to utilize the missing data is impacted. Error concealment processes attempt to minimize the impact of missing data. Error concealment can be performed in many ways such as (but not limited to) a computationally cheap replacement from a previous frame or using more computationally expensive interlayer, temporal or spatial concealment. Interlayer error concealment utilizes a base layer of a video frame, which is the most fundamental information used to reconstruct a video frame, and enhancement layers, which are other layers that produce more refined information when combined with the base layer. Temporal error correction utilizes trends in video frames over a sequence of frames to compensate for decoding errors. Likewise, spatial error concealment utilizes trends within a frame to compensate for decoding errors. In several embodiments, the decoder applies more computationally intensive processes to perform error concealment where the missing data is related to a region of video assigned a high importance value. Less computationally intensive error concealment processes can be applied where missing data is related to a region of video assigned a low importance value.

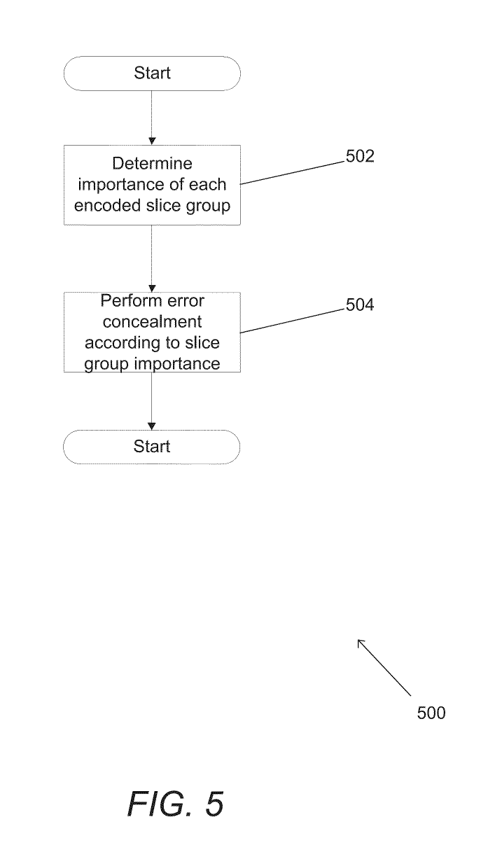

A process for performing error concealment based upon importance values assigned to different regions of video in according with an embodiment of the invention is illustrated in FIG. 5. The process 500 includes determining (502) the degrees of importance of each encoded slice group and performing (504) error concealment according to slice group importance. In many embodiments, a decoder receives encoded data (e.g. a slice group) and an associated importance value. In several embodiments, error concealment is performed (504) with more computationally intensive error concealment for slice groups with greater degrees of importance. Techniques for error concealment include interlayer techniques, temporal technical and spatial techniques. Error concealment can include simple techniques such as replacing errors with data from a previous frame. Certain embodiments employ error concealment that employs a multiphase concealment that includes some or all of interlayer, temporal and special techniques, such as where first interlayer, then temporal and finally spatial concealment is used for error concealment. By performing more computationally intensive error concealment for slice groups of greater degrees of importance, the overall computational complexity can be lowered to save energy and/or enable more effective error concealment on less powerful playback devices, such as mobile devices. Although specific error concealment processes are referenced above, any of a variety of error concealment processes can be applied to regions of video having high importance and/or regions of interest having lower importance as appropriate to the requirements of a specific application in accordance with an embodiment of the invention. Video transmission processes for video decoding in accordance with embodiments of the invention are discussed below.

### Video Transmission

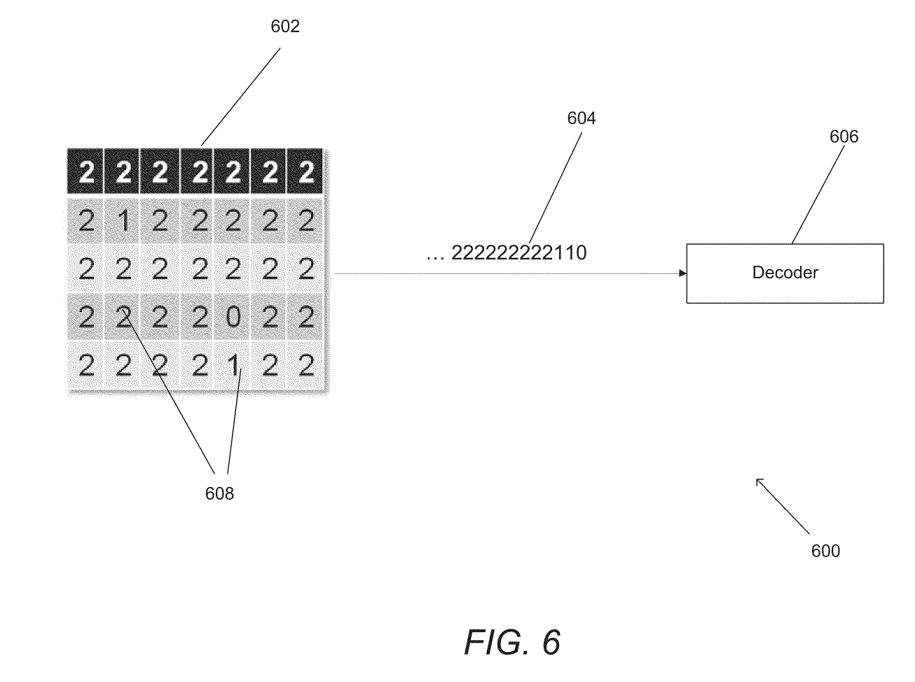

Importance values assigned to regions of video frames can be utilized in accordance with embodiments of the invention to encode the frames of video so that data related to the regions having the highest importance are transmitted before the data associated with less important regions in a video stream. A process of encoding slice groups so that they are grouped in degree of importance for transmission to a decoder in importance order in accordance with an embodiment of the invention is conceptually illustrated in FIG. 6. The process 600 utilizes a video frame 602 including a number of slice groups 608 labeled with corresponding importance values. The encoded video frame 602 can be transmitted as a video stream 604. By encoding the video so that the data associated with different regions is ordered based on importance, the slice groups are transmitted to a decoder (606) in a playback device in order of importance.

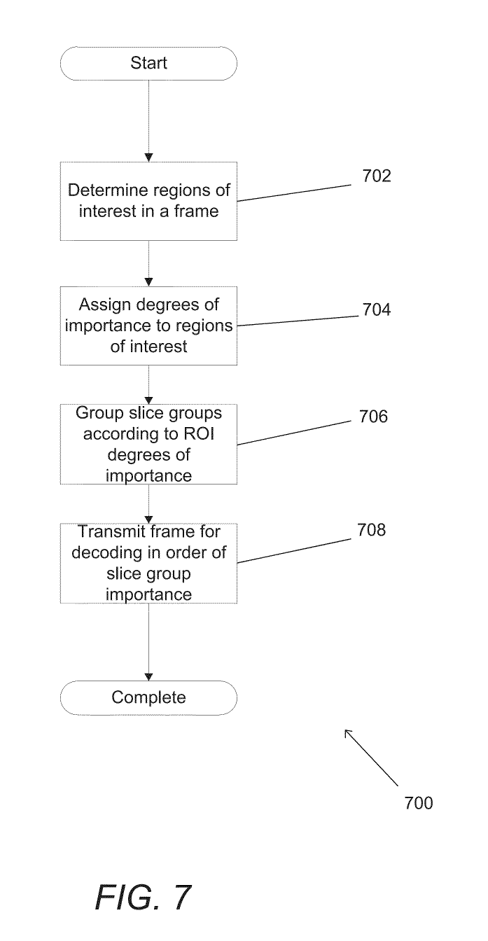

A method of encoding video for transmission of video data within each frame based upon order of importance in accordance with an embodiment of the invention is illustrated in FIG. 7. In many embodiments, transmission of video data is performed by a content distribution application or can be initiated by a playback device using conventional stateless data transmission protocol such as (but not limited to) Hypertext Transfer Protocol. The method 700 includes determining (702) the regions of interest in a frame, assigning (704) importance values to the regions of the frame based upon whether the region includes a region of interest, grouping (706) slice groups according to importance value and streaming (708) each frame for decoding, where the streamed slice groups are ordered based upon importance due to the encoding of the video. Transmitting more important regions of interest first allows for greater fidelity to the captured scene by ensuring that the more important slice groups requiring more processing time and computational resources are received by a decoder first. In this way, there will also be more time to conceal errors that result from loss of data during transmission. Also, fixing the order of transmission and decoding eliminates the need to transmit additional information on the order of slice group transmission while still confirming with standards for encoded video, such as H.264. Although specific embodiments of video processing, such as region of interest identification, encoding, decoding and video stream transmission is described above, any of a variety of video processing can be applied as appropriate to specific applications in accordance with many embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A source encoder, comprising:
a processor configured by an encoder application, where the encoder application configures the processor to:
identify at least one region of interest within a frame of video;
assign at least one importance value to a plurality of regions within the frame, where a higher importance value is assigned to identified regions of interest; and
apply a first error propagation reduction process to at least one region assigned a first importance value and a second error propagation reduction process to at least one region assigned a second importance value.

2. The source encoder of claim 1, wherein the first importance value is higher than the second importance value.

3. The source encoder of claim 2, wherein the first error propagation reduction is more computationally intensive than the second error propagation reduction process.

4. The source encoder of claim 3, wherein the first error propagation reduction process is an adaptive intra refresh encoding process.

5. The source encoder of claim 4, wherein the second error propagation reduction process involves performing no additional error propagation reduction processing.

6. The source encoder of claim 1, wherein the encoder application configures the processor to encode each video frame as a set of slice groups and to assign at least one importance value to each slice group.

7. The source encoder of claim 6, wherein the encoder application configures the processor to group the slice groups in each frame based upon the importance values assigned to the slice groups.

8. The source encoder of claim 1, wherein the encoder application configures the processor to assign importance values based upon user input.

9. The source encoder of claim 1, wherein the encoder application configures the processor to automatically assign importance values using an automated region of interest detection process.

10. A method of encoding video, comprising:
identifying at least one region of interest within a frame of video using a source encoder;
assigning at least one importance value to a plurality of regions within the frame using a source encoder, where a higher importance value is assigned to identified regions of interest; and
applying a first error propagation reduction process to at least one region assigned a first importance value and a second error propagation reduction process to at least one region assigned a second importance value using the source encoder.

11. The method of claim 10, wherein the first importance value is higher than the second importance value.

12. The method of claim 11, wherein the first error propagation reduction is more computationally intensive than the second error propagation reduction process.

13. The method of claim 12, wherein the first error propagation reduction process comprises an adaptive intra refresh encoding process.

14. The method of claim 13, wherein the second error propagation reduction process comprises performing no additional error propagation reduction processing.

15. A playback device, comprising:
a processor configured by a decoder application, where the decoder application configures the processor to:
receive data including a sequence of encoded video frames;
decode the sequence of encoded video frames;
apply a first error concealment process when a region of a frame of video has a first importance value; and
apply a second error concealment process when a region of a frame of video has a second importance value.

16. The playback device of claim 15, wherein the first importance value is higher than the second importance value.

17. The playback device of claim 16, wherein the first error concealment process is more computationally intensive than the second error concealment process.

18. The playback device of claim 15, wherein each video frame is encoded as a set of slice groups and each slice group is assigned at least one importance value.

19. The playback device of claim 18, wherein each video frame is encoded so that the slice groups are grouped based upon importance value.

20. The playback device of claim 19, wherein the decoder application configures the processor to decode slice groups having higher importance values before slice groups having lower importance values.

21. The playback device of claim 15, wherein the first error concealment process includes at least one process selected from the group consisting of an interlayer error concealment process, a temporal error concealment process and a spatial error concealment process.

22. The playback device of claim 15, wherein the importance values are included in the encoded video.

23. The playback device of claim 15, wherein the decoder application configures the processor to assign at least one importance value to regions of the sequence of encoded frames of video.

24. A method of decoding video, comprising:
receiving data including a sequence of encoded video frames using a playback device;
decoding the sequence of encoded video frames using the playback device;
applying a first error concealment process when a region of a frame of video has a first importance value using the playback device; and
applying a second error concealment process when a region of a frame of video has a second importance value using the playback device.

25. The method of claim 24, wherein the first importance value is higher than the second importance value.

26. The method of claim 25, wherein the first error concealment process is more computationally intensive than the second error concealment process.

27. The method of claim 24, wherein the first error concealment process includes at least one process selected from the group consisting of an interlayer error concealment process, a temporal error concealment process and a spatial error concealment process.

28. A machine readable medium containing processor instructions, where execution of the instructions by a processor causes the processor to perform a process comprising:
identifying at least one region of interest within a frame of video;
assigning at least one importance value to a plurality of regions within the frame, where a higher importance value is assigned to identified regions of interest; and
applying a first error propagation reduction process to at least one region assigned a first importance value and a second error propagation reduction process to at least one region assigned a second importance value.

29. The machine readable medium of claim 28, wherein the machine readable medium is non-volatile memory.

30. A machine readable medium containing processor instructions, where execution of the instructions by a processor causes the processor to perform a process comprising:
receiving data including a sequence of encoded video frames;
decoding the sequence of encoded video frames;
applying a first error concealment process when a region of a frame of video has a first importance value; and
applying a second error concealment process when a region of a frame of video has a second importance value.

31. The machine readable medium of claim 30, wherein the machine readable medium is non-volatile memory.
